(19) United States
(12) Patent Application Publication
(10) Pub. No.: US 2003/0051670 A1
(43) Pub. Date: Mar. 20, 2003

(54) Betta fish lid

(76) Inventor: Tony Le, Garden Grove, CA (US)

Correspondence Address: TONY LE, 12211 HACKAMORE ROAD, GARDEN GROVE, CA, 92840, US

(21) Appl. No.: 09/953,762

(22) Filed: Sep. 18, 2001

(51) Int. Cl. A01K 61/02

(52) U.S. Cl. 119/51.04

(57) ABSTRACT

A convenient Lid (FIGS. 1, 2 and 3) specifically designed to fit on the standard clear plastic cup (FIG. 4) available especially for tropical fish market present. To prevent the problem of water spill and sufficient air breathing for the Betta fish, this Lid is incorporate a cylindrical cone in the center and is pointed inward the cup, conditionally the water level must always fill half inch below the tip of the cylindrical cone. When the plastic cup fills with water with the Lid on-as a unit, this unit can be tip or roll any which way, and yet the water still remains inside the cup and air passage is still available. Furthermore, with the Lid secure tight on the plastic cup, it is also an ideal to easily transport, store, display and feed the Betta fish. This invention can be used to store any type of tropical fish (which is not required compress air), marine fish, worm, insect and both live or dry fish food.

### SUMMARY OF INVENTION

This invention relates to Lid and in particular to non-water spilling cup which holds water inside plastic container and act as non-airtight device.

It is, therefore, an object of the invention to provide a 99 percent spill proof lid, which minimizes the depletion of water, an important factor for the fish to survive.

It is another objective of this invention to provide an air passage and feeding port for the fish without having to open the lid.

Further, this invention provides a more efficient way to store or display the fish cup with minimum space needed.

In accordance with this invention, the design of the unit can be shipped by air or ground for any type of Betta fish, live or dry fish food, providing pressurized oxygen is not a requirement.

This invention is more specifically described in the following paragraphs to reference to the drawings attached.

### BRIEF DESCRIPTION OF THE DRAWINGS

A more complete appreciation of this invention, and many of the pertinent advantages thereof, will prevail and become better understandable with accompany illustrations referencing any and all components, wherein:

FIG. 1 illustrates a top view of the Lid.

FIG. 2 illustrates a side and cut away view of the Lid.

FIG. 3 illustrates a bottom view of the Lid.

FIG. 4 illustrates a clear plastic cup, which is standard and available in the tropical fish industry.

FIG. 5 illustrates two sets of cup and Lid hanging like flowerpots.

FIG. 6 illustrates two sets of cup and Lid on the stand.

### DETAILED DESCRIPTION OF THE PREFERRED EMBODIMENT

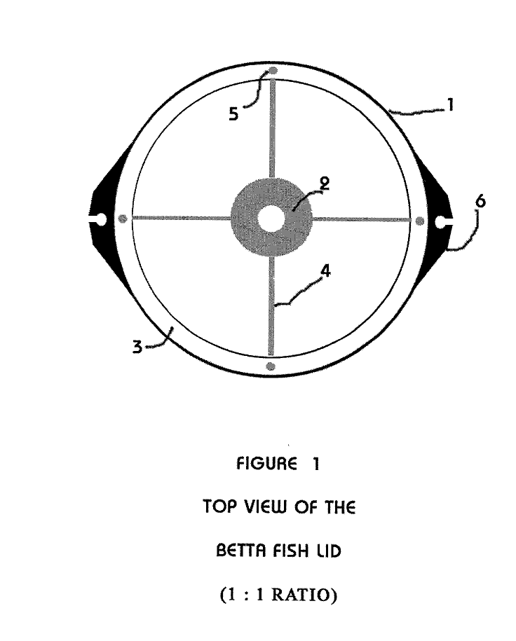

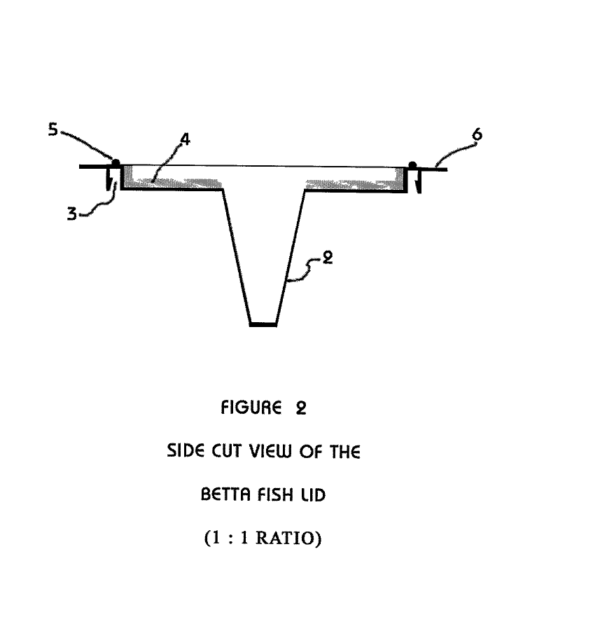

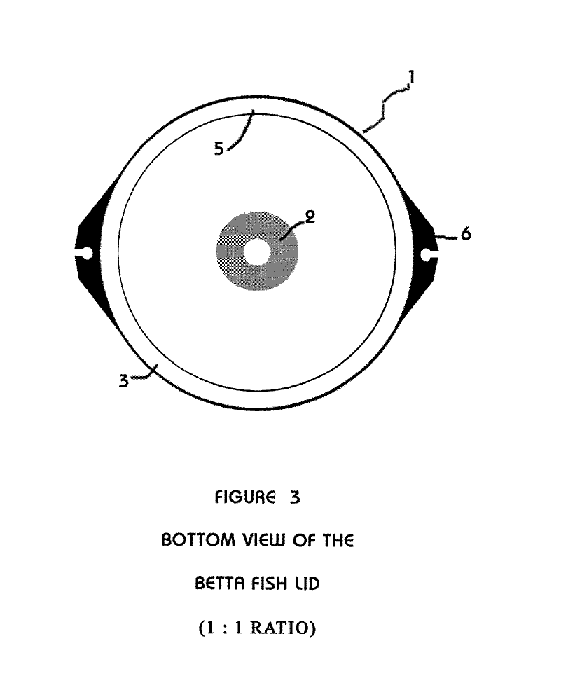

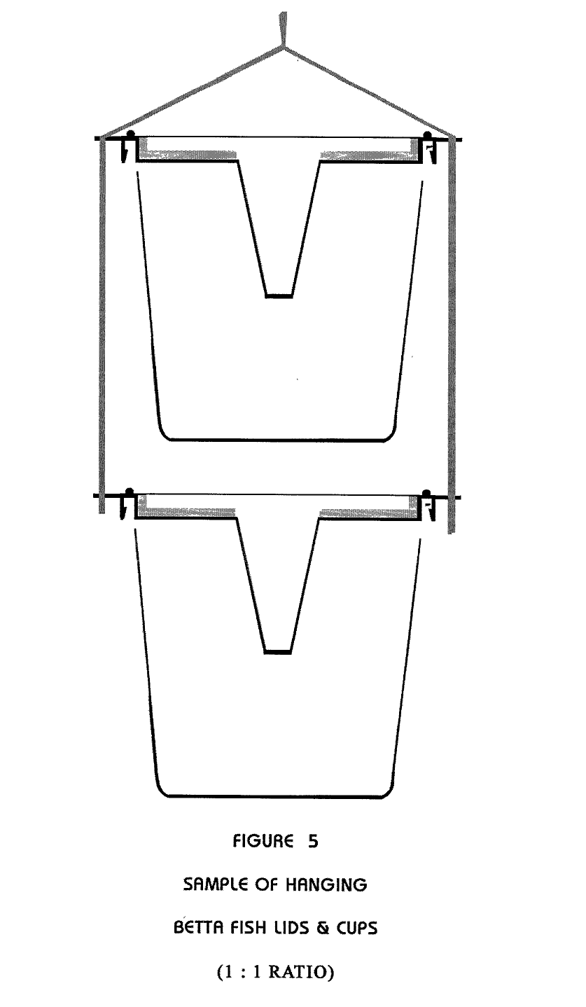

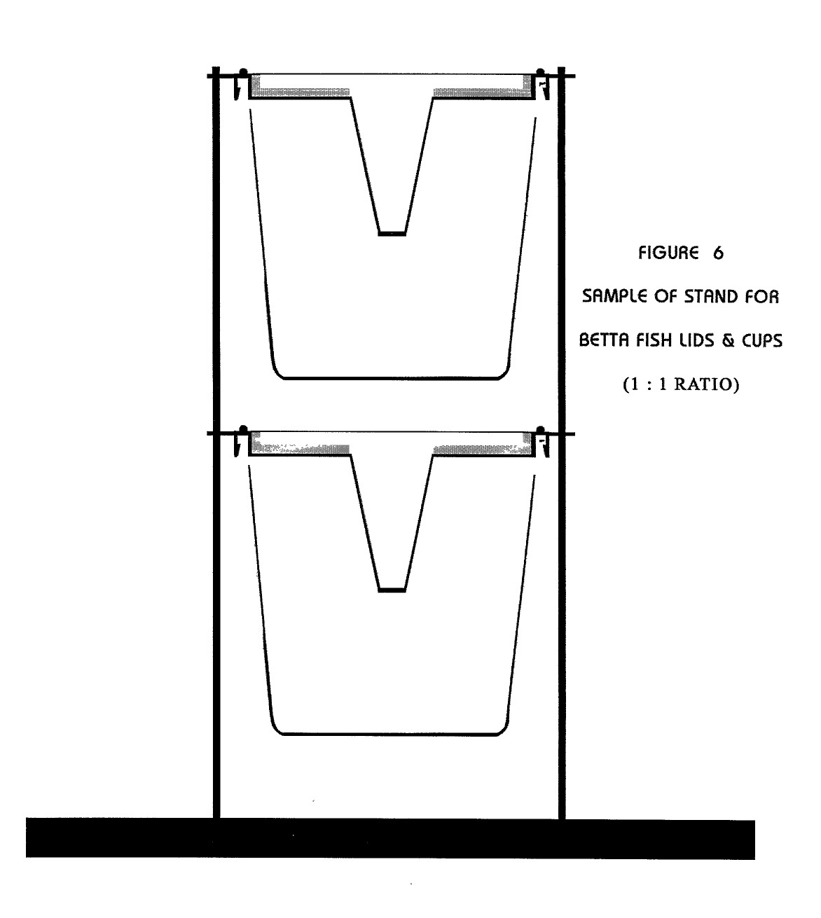

Refer now to FIGS. 1, 2 and 3, which illustrates the top, side and bottom view of the plastic Lid. In those figures, the shaped cone (2) tip was designed at the heart or the center of the cup. If we fill the cup with water up to or below the tip of the cone about half inch, the water surface always stay below the shaped cone's tip (2) no matter which direction we flip or rotate the cup. The second advantage of the shaped cone is for regular feeding of the fish. With live or dry fish food, we can drop the food through the shaped cone port without opening the Lid. The third advantage is providing the breathing port, air for the fish to breath all are going through the shaped cone's port (2). If we stack another cup on this lid, the cross bar (4) will provide an air gap between the cups for the fish to breath. In addition, the four small nipples (5) around the edge also provide air gap if in case the Lid and cup was upside down. Around the edge, there are two earpieces (6), which extend to a quarter of an inch, measuring out from the Lid's edge. The main purpose for this is for hanging (FIG. 5) or putting the cups on a stand (FIG. 6).

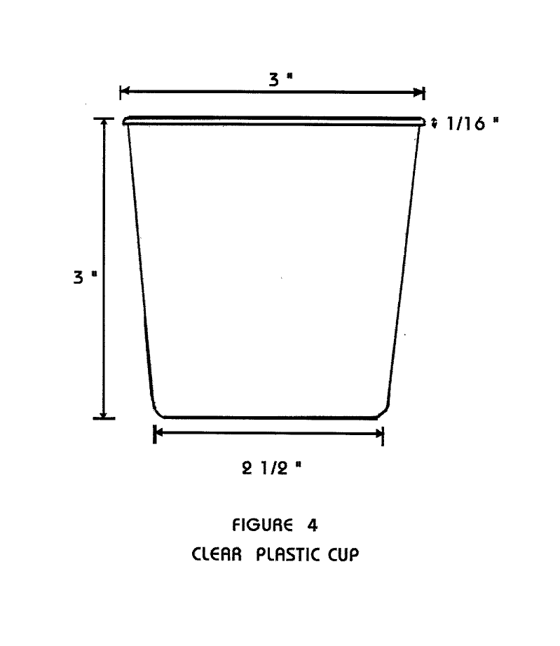

Refer now to FIG. 4, which illustrates the clear plastic cup.

Refer to FIG. 5, which illustrates another way to stack the cups by hanging them using two-piece of fishing lines and a hanging hook.

Refer to FIG. 6, which illustrate another way to store or display the fish by clipping each unit on a stand with two metal rods.

What is claimed is:

1. A 99% spill proof lid, comprises of:
A round plastic lid (1) with facing inward sealed channel around the edge (3) where the shoulder region provides watertight when in contact with the plastic cup's edge.
A cylindrical shaped cone (2) attached to said center of the Lid and protruded from said Lid (1), and the shaped cone (2) always face inward the cup when the lid on top.
Two earpieces (6) with holes extending outward from the Lid's edge (1) and opposite from one to the other.

2. The Lid according to claim 1, wherein said the Lid (1) can be made in CLEAR purple, orange, green, blue, yellow, red, gray, pink and magenta plastic.

3. The Lid according to claim 1, wherein said the Lid (1) can be made in NEON blue, purple, orange, green, blue, yellow, red, pink and magenta plastic.

4. The Lid according to claim 1, wherein said the cylindrical-shaped cone (2) allows circulation of air passage from inside to outside of the cup.

5. The Lid according to claim 1, wherein said the cylindrical shaped cone (2) provides proper port for feeding the fish (inside the cup) without opening the lid.

6. The Lid according to claim 1, wherein said the unit will retain water inside the cup with minimum loss due to vaporization or spillage.

7. The Lid according to claim 1, wherein said that the Lid and the cup act as an unit, it can be stacked up with the identical whole unit without blocking air passage to the bottom cup.

8. The Lid according to claim 1, provides four small nipples (5) on top and around the Lid's edge. The Lid and the cup as a unit can store or stand upside down without losing water or blocking air passages.

9. The Lid according to claim 1, wherein the unit can be hung onto two pieces of fishing line for storage or display through its earpieces (6).

10. The Lid according to claim 1, wherein the unit can be attached to a stand with two thin metal rods for storage or display through its earpieces (6).
